(19) United States
(12) Patent Application Publication
(10) Pub. No.: US 2014/0110641 A1
(43) Pub. Date: Apr. 24, 2014

(54) METHOD FOR PRODUCING ACTIVE MATERIAL PARTICLES FOR LITHIUM ION SECONDARY BATTERY, ELECTRODE AND LITHIUM ION SECONDARY BATTERY

(71) Applicant: ASAHI GLASS COMPANY, LIMITED, Chiyoda-ku (JP)

(72) Inventors: Eisuke MUROTANI, Tokyo (JP); Kentaro TSUNOZAKI, Tokyo (JP); Takeshi KAWASATO, Tokyo (JP)

(73) Assignee: ASAHI GLASS COMPANY, LIMITED, Chiyoda-ku (JP)

(21) Appl. No.: 14/140,059

(22) Filed: Dec. 24, 2013

Related U.S. Application Data
(63) Continuation of application No. PCT/JP2012/066059, filed on Jun. 22, 2012.

(30) Foreign Application Priority Data
Jun. 24, 2011 (JP) 2011-140492

(51) Int. Cl. H01M 4/36; C08K 3/22

(52) U.S. Cl. CPC H01M 4/364; C08K 3/22
USPC 252/519.15; 252/182.1

(57) ABSTRACT

To produce active material particles for a lithium ion secondary battery, which have favorable surface smoothness, with which the cycle characteristics can be improved while an increase in the internal resistance of an active material layer is suppressed, and with which decomposition of the electrolyte can be suppressed even at a high voltage.

Active material particles (X) for a lithium ion secondary battery are contacted with a composition containing a compound (a) having a metal element (M) selected from the group consisting of Li, Mg, Ca, Sr, Ba, Pb, Y, Ti, Zr, Hf, V, Nb, Ta, Cr, Mo, W, Mn, Fe, Co, Ni, Cu, Zn, Al, In, Sn, Sb, Bi, La, Ce, Pr, Nd, Gd, Dy, Er and Yb and a composition containing a fluoropolymer (b) having repeating units represented by —[CF₂—CR¹, R²]— (wherein each of R¹ and R² is H, F or —CF₃), followed by heating.

### TECHNICAL FIELD

The present invention relates to a method for producing active material particles for a lithium ion secondary battery, an electrode containing active material particles obtained by the production method, and a lithium ion secondary battery having the electrode.

### BACKGROUND ART

Lithium ion secondary batteries are widely used for portable electronic instruments such as cell phones or notebook-size personal computers, and their application to automobiles in recent years are expected. As a cathode active material for a lithium ion secondary battery, a composite oxide of a transition metal with lithium, etc., such as LiCoO₂, LiNiO₂, LiNi_{0.8}Co_{0.2}O₂ or LiMn₂O₄, is employed. Particularly, a lithium ion secondary battery using LiCoO₂ as a cathode active material and a lithium alloy or carbon such as graphite or carbon fibers as an anode has been widely used as a battery having a high energy density, whereby a high voltage at a level of 4 V is obtained. In recent years, it is desired to further reduce the size and weight as a lithium ion secondary battery for portable electronic instruments or vehicles, and a high voltage and high capacity material is desired so as to increase the energy density. At the same time, the improvement in cycle characteristics, with which a battery can be stably used for a long period of time, is also highly desired.

However, if charge/discharge is repeatedly carried at a high voltage, the active material itself is deteriorated, or the active material and the electrolyte are contacted and reacted, whereby the cycle characteristics are deteriorated.

Therefore, to solve such a problem, it has been studied to cover the surface of active material particles with an inorganic compound. For example, Patent Document 1 discloses a method of preventing deterioration of the active material during charging up at a high voltage by covering the surface of active material particles with zirconium oxide. However, if the entire surface of the active material particles is covered with an inorganic material, absorption/desorption of lithium ions tends to be difficult, such that the diffusion rate of lithium ions is decreased, whereby the internal resistance tends to be high.

Patent Document 2 discloses a method of forming pores in which movement of lithium ions is possible in a covering layer, by once covering the surface of active material particles with inorganic metal oxide fine particles, then mechanically applying a shearing stress so that part of the fine particles constituting the covering layer are intentionally made to slip off.

By this method, movement of lithium ions is possible, however, the active material surface with high activity is exposed again at a portion where the fine particles slipped off, whereby contact with the electrolyte cannot be prevented, and decomposition of the electrolyte at a high voltage cannot be suppressed. Further, as a result of slippage of part of the fine particles in the covering layer, irregularities on the surface of the entire active material particles tend to be significant, and the surface smoothness will be decreased. Accordingly, this method has such a drawback that the electrode active material layer can hardly be filled with the active material particles uniformly at a high density.

On the other hand, to suppress decomposition of the electrolyte, a method has also been studied to cover the surface of the active material particles with a fluorinated type material having high oxidation resistance. For example, Patent Document 3 discloses to cover from 10 to 90% of the surface of the active material particles with a fluorinated material, and it is attempted to reduce the contact area of the surface of the active material and the electrolyte.

Further, Non-Patent Document 1 discloses that the interface resistance between the active material layer and the electrolyte is reduced by coating the cathode active material layer with a polymer. This indicates that covering with a polymer does not inhibit movement of lithium ions by charge/discharge and will not be a large resistance component.

However, coating with a fluorinated material or a polymer has no effect to prevent deterioration of the active material particles, and the effect to improve the cycle characteristics is small as compared with a case of covering the active material particles with an inorganic compound.

Patent Document 4 discloses a method of forming an active material layer on a current collector, and applying a solution containing both of inorganic particles and an acrylic binder to the surface of the active material layer for covering. However, this method is to prevent internal short circuit, and only the outermost surface of the active material layer is covered. Further, since the polymer material is an acrylic material, use at a high voltage where an oxidizing property is high may cause a problem such as decomposition of the electrolyte.

### PRIOR ART DOCUMENTS

### Patent Documents

Patent Document 1: JP-A-2004-175609
Patent Document 2: JP-A-2009-76279
Patent Document 3: Japanese Patent No. 4616592
Patent Document 4: WO2010/073924

### Non-Patent Document

Non-Patent Document 1: Electrochimica Acta, 53 (2008), 8196-8202

### DISCLOSURE OF INVENTION

### Technical Problem

As mentioned above, by conventional methods, it is difficult to satisfy all of an improvement in the cycle characteristics without increasing the internal resistance of the electrode active material layer, a decrease in the internal resistance without impairing the surface smoothness of the active material particles and prevention of decomposition of the electrolyte even by use at a high voltage simultaneously.

Under these circumstances, the object of the present invention is to provide a method for producing active material particles for a lithium ion secondary battery such that the surface smoothness of the active material particles is preferred, the cycle characteristics can be improved while an increase in the internal resistance of the active material layer is suppressed, and decomposition of the electrolyte can favorably be suppressed even by use at a high voltage, an electrode containing active material particles obtained by the production method, and a lithium ion secondary battery having the electrode.

### Solution to Problem

The method for producing active material particles for a lithium ion secondary battery of the present invention comprises contacting active material particles (X) for a lithium ion secondary battery capable of oxidation/reduction reaction, with a composition containing a compound (a) having at least one metal element (M) selected from the following metal element group (A) and a composition containing the following fluoropolymer (b), and heating them:

metal element group (A): a group consisting of Li, Mg, Ca, Sr, Ba, Pb, Y, Ti, Zr, Hf, V, Nb, Ta, Cr, Mo, W, Mn, Fe, Co, Ni, Cu, Zn, Al, In, Sn, Sb, Bi, La, Ce, Pr, Nd, Gd, Dy, Er and Yb;

fluoropolymer (b): a polymer having repeating units represented by the following formula (1):

—[CF₂—CR¹R²]— (1)

wherein each of R¹ and R² is a hydrogen atom, a fluorine atom or a trifluoromethyl group.

It is preferred that the contacting step is a step of contacting the particles (X) with a composition containing both of the compound (a) and the fluoropolymer (b).

It is preferred that the composition containing the compound (a) is a powder or dispersion of an oxide (a1) of at least one metal element (M1) selected from the following metal element group (A1); and the composition containing the fluoropolymer (b) is a powder, solution or dispersion of the fluoropolymer (b).

metal element group (A1): a group consisting of Zr, Ti, Sn, Mg, Ba, Pb, Bi, Nb, Ta, Zn, Y, La, Sr, Ce, In and Al.

It is preferred that the oxide (a1) is at least one member selected from the group consisting of ZrO₂, TiO₂, SnO₂, MgO, BaO, PbO, Bi₂O₃, Nb₂O₅, Ta₂O₅, ZnO, Y₂O₃, La₂O₃, Sr₂O₃, CeO₂, In₂O₃, Al₂O₃, indium tin oxide (ITO), yttria-stabilized zirconia (YSZ), metal barium titanate, strontium titanate and zinc stannate.

It is preferred that the composition containing the compound (a) is a dispersion of the oxide (a1), and the composition containing the fluoropolymer (b) is a solution or dispersion.

It is preferred that the contacting step is a step of spraying a dispersion containing both of the oxide (a1) and the fluoropolymer (b) to the active material particles (X) for a lithium ion secondary battery.

It is preferred that heating is carried out at a temperature of from 50 to 350° C.

It is preferred that the fluoropolymer (b) is at least one member selected from the group consisting of polytetrafluoroethylene (PTFE), polyvinylidene fluoride (PVdF), a tetrafluoroethylene/ethylene copolymer (ETFE), a tetrafluoroethylene/propylene copolymer and a tetrafluoroethylene/sulfonyl group-containing perfluorovinyl ether copolymer.

It is preferred that the active material particles (X) for a lithium ion secondary battery are lithium-containing composite oxide particles.

It is preferred that the lithium-containing composite oxide particles contain Li element and at least one transition metal element selected from the group consisting of Ni, Co and Mn, the molar amount of the Li element being more than 1.2 times of the total molar amount of the transition metal element.

The present invention provides an electrode for a lithium ion secondary battery, which comprises an electrode active material layer containing the active material particles for a lithium ion secondary battery obtained by the production method of the present invention, an electrically conductive material and a binder.

The present invention provides a lithium ion secondary battery comprising the electrode for a lithium ion secondary battery of the present invention.

### Advantageous Effects of Invention

According to the present invention, it is possible to obtain active material particles for a lithium ion secondary battery such that the surface smoothness of the active material particles is preferred, the cycle characteristics can be improved while an increase in the internal resistance of the electrode active material layer is suppressed, and decomposition of the electrolyte can favorably be suppressed even by use at a high voltage.

An electrode containing the active material particles obtained by the production method of the present invention, and a lithium ion secondary battery having the electrode, are such that the internal resistance of the electrode active material layer is small, the cycle characteristics are good, and decomposition of the electrolyte can favorably be suppressed even by use at a high voltage. Further, since the surface smoothness of the active material particles is good, the electrode can be packed with the active material particles at a high density, and the energy density per unit volume of the electrode can be improved. Accordingly, it is possible to realize a lithium ion secondary battery having a high voltage and a high capacity and also being excellent in the cycle characteristics.

### DESCRIPTION OF EMBODIMENTS

### Active Material Particles (X) for a Lithium Ion Secondary Battery

In the present invention, active material particles (X) for a lithium ion secondary battery capable of oxidation/reduction reaction (hereinafter sometimes referred to simply as particles (X)) are used.

The particles mean particles to be a starting material before contacted with the after-mentioned composition in the production method of the present invention.

As the particles (X), known active material particles (active material particles for a cathode or active material particles for an anode) for a lithium ion secondary battery may properly be used.

The average particle size (D50) of the particles (X) is preferably from 10 nm to 30 μm, more preferably from 1 to 25 μm, particularly preferably from 2 to 15 μm. The particles may be secondary particles having primary particles agglomerated. The average particle size of the primary particles constituting the secondary particles is preferably from 0.01 to 5 μm.

In this specification, the average particle size D50 means a volume-based cumulative 50% size (D50) which is a particles size at a point of 50% on an accumulative curve when the accumulative curve is drawn by obtaining the particle size distribution on the volume basis and taking the whole to be 100%. The particle size distribution is obtained from the frequency distribution and accumulative volume distribution curve measured by means of a laser scattering particle size distribution measuring apparatus. The measurement of particles sizes is carried out by sufficiently dispersing the powder in an aqueous medium by e.g. an ultrasonic treatment and measuring the particle size distribution (for example, by means of a laser diffraction/scattering type particle size distribution measuring apparatus Partica LA-950VII, manufactured by HORIBA, LTD.).

The specific surface area of the particles (X) by BET (Brunauer, Emmett, Teller) method is preferably from 0.1 to 10 m²/g, particularly preferably from 0.2 to 5 m²/g. When the specific surface area is from 0.1 to 10 m²/g, a high capacity and dense electrode active material layer is likely to be formed.

In a case where the active material particles for a lithium ion secondary battery to be produced by the production method of the present invention (hereinafter sometimes referred to simply as active material particles) are active material particles for a cathode, the particles (X) are preferably particles comprising a lithium-containing composite oxide using at least one transition element. The transition metal element is preferably V, Ti, Cr, Mn, Fe, Co, Ni or Cu.

The lithium-containing composite oxide may, for example, be preferably a compound (i) represented by the following formula (i); an olivin metal lithium salt (ii) which is a substance represented by the following formula (ii) or a composite thereof; a compound (iii) containing Li element and at least one transition metal element selected from the group consisting of Ni, Co and Mn, the molar amount of the Li element being more than 1.2 times of the total molar amount of the transition metal element {(molar amount of Li element/total molar amount of transition metal element)>1.2}; or a compound (iv) represented by the following formula (iv). These materials may be used alone or in combination of two or more.

Liₐ(NiₓMn_{y}Co_{z})M_{b}O₂ Formula (i):

wherein 0.95≦a≦1.1, 0≦x≦1, 0≦y≦1, 0≦z≦1, 0≦b≦0.3, 0.90≦x+y+z+b≦1.05, and M is at least one member selected from the group consisting of Mg, Ca, Sr, Ba and Al.

Examples of the compound (i) represented by the formula (i) include LiCoO₂, LiNiO₂, LiMnO₂, LiMn_{0.5}Ni_{0.5}O₂, LiNi_{0.85}CO_{0.10}Al_{0.05}O₂, and LiNi_{1/3}CO_{1/3}Mn_{1/3}O₂.

Li_{L}X_{x′}Y_{y′}O_{z′}F_{g} Formula (ii):

wherein X is Fe(II), Co(II), Mn(II), Ni(II), V(II) or Cu(II), Y is P or Si, 0≦L≦3, 1≦x′≦2, 1≦y′≦3, 4≦z′≦12, and 0≦g≦1.

Examples of the olivin metal lithium salt (ii) include LiFePO₄, Li₃Fe₂(PO₄)₃, LiFeP₂O₇, LiMnPO₄, LiNiPO₄, LiCoPO₄, Li₂FePO₄F, Li₂MnPO₄F, Li₂NiPO₄F, Li₂CoPO₄F, Li₂FeSiO₄, Li₂MnSiO₄, Li₂NiSiO₄ and Li₂CoSiO₄.

The compound (iii) is a compound containing Li element and at least one transition metal element selected from the group consisting of Ni, Co and Mn, the molar amount of the Li element being more than 1.2 times of the total molar amount of the transition metal element, and is thereby preferred with a view to improving the discharge capacity per unit mass.

The compositional ratio (molar amount) of the Li element to the total molar amount of the transition metal element is preferably from 1.25 to 1.75, more preferably from 1.35 to 1.65, particularly preferably from 1.40 to 1.55, so as to further improve the discharge capacity per unit mass.

The compound (iii) should contain, as the transition metal element, at least one element selected from the group consisting of Ni, Co and Mn, preferably contains at least Mn element, particularly preferably contains all the elements of Ni, Co and Mn. It may further contain, as the transition metal element, as the case requires, an element such as Cr, Fe, Al, Ti, Zr or Mg. Specifically, preferred is a compound represented by the following formula (iii-1).

Li(LiₓMn_{y}Me_{z})OₚF_{q} Formula (iii-1):

wherein Me is at least one element selected from the group consisting of Co, Ni, Cr, Fe, Al, Ti, Zr, and Mg, 0.09<x<0.3, 0.4≦y/(y+z)≦0.8, x+y+z=1, 1.9<p<2.1, and 0≦q≦0.1.

Me in the formula (iii-1) is preferably Co, Ni or Cr, particularly preferably Co or Ni. In the formula (iii-1), preferably 0.1<x<0.25, more preferably 0.11<x<0.22, preferably 0.5≦y/(y+z)≦0.8, more preferably 0.55<y/(y+z)≦0.75.

The compound represented by the above formula (iii-1) is specifically preferably Li(Li_{0.13}Ni_{0.26}Co_{0.09}Mn_{0.52})O₂, Li(Li_{0.13}Ni_{0.22}CO_{0.09}Mn_{0.56})O₂, Li(Li_{0.13}Ni_{0.17}Co_{0.17}Mn_{0.53})O₂, Li(Li_{0.15}Ni_{0.17}Co_{0.13}Mn_{0.55})O₂, Li(Li_{0.16}Ni_{0.17}Co_{0.08}Mn_{0.59})O₂, Li(Li_{0.17}Ni_{0.17}Co_{0.17}Mn_{0.49})O₂, Li(Li_{0.17}Ni_{0.21}Co_{0.08}Mn_{0.54})O₂, Li(Li_{0.17}Ni_{0.14}Co_{0.14}Mn_{0.55})O₂, Li(Li_{0.18}Ni_{0.12}Co_{0.12}Mn_{0.58})O₂, Li(Li_{0.18}Ni_{0.16}CO_{0.12}Mn_{0.54})O₂, Li(Li_{0.20}Ni_{0.12}Co_{0.08}Mn_{0.60})O₂, Li(Li_{0.20}Ni_{0.16}Co_{00.8}Mn_{0.56})O₂, Li(Li_{0.20}Ni_{0.13}CO_{0.13}Mn_{0.54})O₂, Li(Li_{0.22}Ni_{0.12}CO_{0.12}Mn_{0.54})O₂, or Li(Li_{0.23}Ni_{0.12}Co_{0.08}Mn_{0.57})O₂, particularly preferably Li(Li_{0.16}Ni_{0.17}Co_{0.08}Mn_{0.59})O₂, Li(Li_{0.17}Ni_{0.17}Co_{0.17}Mn_{0.49})O₂, Li(Li_{0.17}Ni_{0.21}Co_{0.08}Mn_{0.54}O₂, Li(Li_{0.17}Ni_{0.14}CO_{0.14}Mn_{0.55})O₂, Li(Li_{0.18}Ni_{0.12}Co_{0.12}Mn_{0.58})O₂, Li(Li_{0.18}Ni_{0.16}CO_{0.12}Mn_{0.54})O₂, Li(Li_{0.20}Ni_{0.12}Co_{0.08}Mn_{0.60})O₂, Li(Li_{0.20}Ni_{0.16}Co_{0.08}Mn_{0.56})O₂, or Li(Li_{0.20}Ni_{0.13}Co_{0.13}Mn_{0.54})O₂.

The compound represented by the above formula (iii-1) is preferably one having a layered rock salt type crystal structure (space group R-3m). Further, as the proportion of the Li element to the transition metal element is high, in the XRD (X-ray diffraction) measurement, a peak is observed within a range of 2θ=20 to 25° like layered Li₂MnO₃.

Li(Mn₂₋ₓMeₓ)O₄ Formula (iv):

wherein 0≦x<2, and Me is at least one member selected from the group consisting of Co, Ni, Fe, Ti, Cr, Mg, Ba, Nb, Ag and Al.

Examples of the compound (iv) represented by the formula (iv) include LiMn₂O₄, LiMn_{1.5}Ni_{0.5}O₄, LiMn_{1.0}Co_{1.0}O₄, LiMn_{1.85}Al_{0.15}O₄, and LiMn_{1.9}Mg_{0.1}O₄.

In a case where the active material particles produced by the production method of the present invention are active material particles for an anode, the particles (X) are not particularly limited so long as they are capable of adsorbing and desorbing lithium ions, and they are preferably particles selected from particles comprising a wide variety of carbon ranging from crystalline graphite to amorphous carbon, or a carbon composite, particles comprising lithium metal, or metal particles capable of being alloyed with lithium.

The particles comprising carbon or a carbon composite may, for example, be natural graphite, artificial graphite, or carbon black (such as furnace black, channel black, acetylene black, thermal black, lampblack or ketjen black). These materials may be used alone or in combination of two or more.

As the metal particles capable of being alloyed with lithium ion, any known metal particles may be used, however, in view of the capacity and the cycle life, preferred is a metal selected from the group consisting of Si, Sn, As, Sb, Al, Zn and W. Particularly, Si or Sn which has a high capacity to absorb and desorb lithium ions and with which high energy density will be obtained, is suitable. Further, an alloy comprising two or more metals may be used, and specific examples include an ionic metal alloy such as SnSb or SnAs, and a layered alloy such as NiSi2 or CuS2. Such materials may be used alone or in combination of two or more.

<Fluoropolymer (b)>

The fluoropolymer (b) to be used in the present invention is a polymer having repeating units represented by the following formula (1):

—[CF₂—CR¹R²]— (1)

wherein each of R¹ and R² which is independent of each other, is a hydrogen atom, a fluorine atom or a trifluoromethyl group.

The fluoropolymer (b) to be used in the present invention is not limited so long as it contains repeating units represented by the formula (1) and may be a homopolymer or a copolymer. The content of the repeating units represented by the formula (1) is preferably from 20 to 100 mol %, more preferably from 40 to 100%, per 100 mol % of the number of all the repeating units in the fluoropolymer (b).

Specific examples of the fluoropolymer (b) include polytetrafluoroethylene (PTFE), polyvinylidene fluoride (PVdF), a tetrafluoroethylene/ethylene copolymer (ETFE), a tetrafluoroethylene/propylene copolymer, a tetrafluoroethylene/perfluoroalkyl vinyl ether copolymer (PFA), a tetrafluoroethylene/hexafluoropropylene copolymer (HFP), a vinylidene fluoride/hexafluoropropylene copolymer, a tetrafluoroethylene/hexafluoropropylene/vinylidene fluoride copolymer, a tetrafluoroethylene/propylene/vinylidene fluoride copolymer and a tetrafluoeoethylene/sulfonyl group-containing perfluorovinyl ether copolymer. They may be used alone or in combination of two or more.

Among them, preferred is polytetrafluoroethylene (PTFE), polyvinylidene fluoride (PVdF), a tetrafluoroethylene/ethylene copolymer (ETFE), a tetrafluoroethylene/propylene copolymer or a tetrafluoroethylene/sulfonyl group-containing perfluorovinyl ether copolymer in view of high chemical stability and good film forming property.

The weight average molecular weight of the fluoropolymer (b) is preferably from 50,000 to 2,000,000, more preferably from 100,000 to 2,000,000. When it is at most the upper limit, the viscosity will not be too high, whereby the workability will not be impaired, and when it is at least the lower limit, sufficient film forming property will be maintained.

The weight average molecular weight in this specification is a molecular weight as calculated as polystyrene, obtained by measurement by means of gel permeation chromatography using a calibration curve prepared by using a standard polystyrene sample having a known molecular weight.

The molecular weight of PTFE may be obtained, for example, by a method as disclosed in “Fluororesin handbook” (THE NIKKAN KOGYO SHIMBUN, LTD.).

The composition containing the fluoropolymer (b) to be used in the present invention may be a powder, solution or dispersion. The solution means a uniform mixture in a liquid state and the dispersion means a mixture in which a dispersoid in the form of fine particles is present in a liquid dispersion medium.

The solvent of the solution or the dispersion medium of the dispersion is preferably an aqueous medium composed mainly of water. The water content in the aqueous medium is preferably at least 80 mass %, more preferably at least 90 mass %. The aqueous medium is particularly preferably composed solely of water, in view of excellent safety, environmental effect, handling efficiency and cost.

As a component other than water contained in the aqueous medium, a component which will not impair solubility or dispersability is used. For example, a water soluble alcohol and/or polyol is preferred.

The water soluble alcohol may be methanol, ethanol, 1-propanol or 2-propanol. The polyol may be ethylene glycol, propylene glycol, diethylene glycol, dipropylene glycol, polyethylene glycol, butanediol or glycerin.

In a case where the solvent of the solution or the dispersion medium of the dispersion containing the fluoropolymer (b) is not an aqueous medium, the solvent or dispersion medium may, for example, be N,N-dimethylacetamide (DMAc), N,N-dimethylformamide (DMF), dimethylsulfoxide (DMSO), N-methyl-2-pyrolidone (NMP), tetrahydrofuran (THF), acetone, a fluoroalkane (such as C₆F₁₃H), or a fluoroether (such as CF₃CH₂OCF₂CF₂H, CF₃CH₂OCF₂CFHCF₃ or HCF₂CF₂CH₂OCF₂CFHCF₃).

### <Method for Producing Active Material Particles for Lithium Ion Secondary Battery>

In the present invention, by means of a step of contacting the particles (X) with a composition containing a compound (a) having at least one metal element (M) selected from the following metal element group (A) and a composition containing the fluoropolymer (b) and heating them in a state where they are contacted, active material particles having an inorganic compound containing the metal element (M) and the fluoropolymer (b) attached to the surface of the particles (X) are produced.

Metal element group (A): A group consisting of Li, Mg, Ca, Sr, Ba, Pb, Y, Ti, Zr, Hf, V, Nb, Ta, Cr, Mo, W, Mn, Fe, Co, Ni, Cu, Zn, Al, In, Sn, Sb, Bi, La, Ce, Pr, Nd, Gd, Dy, Er and Yb.

The inorganic compound containing the metal element (M) is preferably a metal oxide or a metal salt which is hardly soluble in water. In this specification, of the active material particles, a portion other than the particles (X) will be referred to as a covering layer.

In the present invention, the composition containing the compound (a) and the composition containing the fluoropolymer (b) may be separate compositions, or may be the same composition. That is, a composition containing both of the compound (a) and the fluoropolymer (b) may be used.

It is preferred to contact the particles (X) with a composition containing both of the compound (a) and the fluoropolymer (b), whereby the inorganic compound containing the metal element (M) and the fluoropolymer (b) are likely to be uniformly attached to the surface of the particles (X).

In a case where the inorganic compound in the covering layer is a metal oxide, the following (method 1) or (method 2) is preferably used. In a case where the inorganic compound in the covering layer is a metal salt which is hardly soluble in water, the following (method 3) is preferably used.

(Method 1): A method of using a metal oxide as the compound (a) containing the metal element (M).

In this method, the particles (X) are contacted with a composition containing the metal oxide and a composition containing the fluoropolymer (b), and they are heated in a state where they are contacted. The metal oxide is preferably a compound inert to a decomposed product, so as to prevent contact with the decomposed product formed by decomposition of the electrolyte by charge (oxidation reaction) at a high voltage.

(Method 2): A method of using a compound which forms a metal oxide by heating, as the compound (a) having the metal element (M).

In this method, the particles (X) are contacted with a composition containing the compound and a composition containing the fluoropolymer (b) and heating them in a state where they are contacted.

That is, the compound (a) is a compound (a2) which has at least one metal element (M2) selected from the following metal element group (A2), and which forms an oxide of the metal element (M2) by heating, and by carrying out heating in an oxidizing atmosphere, an oxide of the metal element (M2) is formed.

Metal element group (A2): A group consisting of Zr, Ti, Mn, Mo, Nb and Al.

(Method 3): A method of using a water soluble compound which reacts with anion in water to form a salt, as the compound (a) having the metal element (M).

In this method, the particles (X) are contacted with a solution containing a water soluble compound to be an anion source, a solution containing a water soluble compound reactive with the compound to form a salt, and a solution containing the fluoropolymer (b), and they are heated in a state where they are contacted.

That is, the composition containing the compound (a) is a solution of a water soluble compound (a3) containing at least one metal element (M) selected from the above metal element group (A), and the contacting step is a step of contacting the active material particles (X) for a lithium ion secondary battery with a solution containing the water soluble compound (a3), a solution or dispersion containing the fluoropolymer (b) and a solution containing the following water soluble compound (c).

Water soluble compound (c): a water soluble compound containing at least one element selected from the group consisting of S, P, F and B, and an anion (N) reactive with the metal element (M) to form a hardly soluble metal salt.

Now, (method 1) to (method 3) will be described.

### <Method 1>

[Oxide (a1) of Metal Element (M1)]

In (method 1), as the compound (a) having the metal element (M), it is preferred to use an oxide (a1) of at least one metal element (M1) selected from the following metal element group (A1). The oxide (a1) is in the form of particles. The oxides (a1) may be used alone or in combination of two or more.

Metal element group (A1): a group consisting of Zr, Ti, Sn, Mg, Ba, Pb, Bi, Nb, Ta, Zn, Y, La, Sr, Ce, In and Al.

Specific examples of the oxide (a1) include ZrO₂, TiO₂, SnO₂, MgO, BaO, PbO, Bi₂O₃, Nb₂O₅, Ta₂O₅, ZnO, Y₂O₃, La₂O₃, Sr₂O₃, CeO₂, In₂O₃, Al₂O₃, indium tin oxide (ITO), yttria-stabilized zirconia (YSZ), metal barium titanate, strontium titanate and zinc stannate. The oxide (a1) is preferably an oxide containing Zr element, particularly preferably ZrO₂, with which a uniform covering layer is likely to be obtained and which is chemically stable.

The average particle size of the oxide (a1) is preferably from 1 to 100 nm, more preferably from 2 to 50 nm, particularly preferably from 3 to 30 nm. When the average particle size is at least the lower limit of the above range, the amount of impurities tends to be small. Further, a stable dispersion is likely to be obtained when dispersed in a dispersion medium. When it is at most the upper limit, the particles of the oxide (a1) are likely to be uniformly attached to the surface of the particles (X).

The average particle size of the oxide (a1) is a median diameter of particles measured by a dynamic light scattering method and is measured in a state where the particles of the oxide (a1) are dispersed in water (for example, Nanotrac UPA manufactured by NIKKISO CO., LTD. is used).

[Composition Containing Oxide (a1)]

As the composition containing the oxide (a1), the oxide (a1) may be used in a powdery state, or a dispersion having the oxide (a1) dispersed in a dispersion medium may be used. The dispersion medium is preferably an aqueous medium composed mainly of water in view of the stability and the reactivity of the oxide (a1). The aqueous medium is the same as the aqueous medium of the composition containing the fluoropolymer (b) including the preferred embodiments.

In the dispersion of the oxide (a1), pH controlling agent may be contained. The pH controlling agent is preferably one which is volatilized or decomposed at the time of heating. Specifically, preferred is an organic acid such as acetic acid, citric acid, lactic acid or formic acid, or ammonia.

The pH of the dispersion of the oxide (a1) is preferably from 3 to 12, more preferably from 3.5 to 12, particularly preferably from 4 to 10. When the pH is within the above range, the amount of impurities such as the pH controlling agent tends to be small, whereby favorable battery characteristics are likely to be obtained. Further, in a case where the particles (X) contain Li element, when the particles (X) are contacted with the dispersion of the oxide (a1), elution of the Li element from the particles (X) is likely to be suppressed.

To prepare the dispersion of the oxide (a1), it is desirable to carry out dispersion treatment as the case requires. As the dispersion treatment method, a known apparatus such as a ball mill, a bead mill, a high-pressure homogenizer, a high speed homogenizer or an ultrasonic dispersion apparatus may be used. By the dispersion treatment, dispersion of the oxide (a1) in the dispersion medium will easily proceed, and the oxide (a1) is likely to be stably dispersed. To improve dispersability of the particles of the oxide (a1), a high molecular weight dispersing agent and/or a surfactant may be contained in the dispersion. However, if the high molecular weight dispersing agent or the surfactant remains in the electrode, the battery characteristics will be impaired, and accordingly the total content of the high molecular weight dispersing agent and the surfactant in the dispersion of the oxide (a1) is preferably at most 3 mass % to the total amount of particles of the oxide (a1). It is more preferably at most 1 mass %, particularly preferably from 0 to 0.1 mass %.

The dispersion of the oxide (a1) may be commercially available.

[Step of Contacting Particles (X) with Composition]

In the step of contacting the particles (X) with the composition containing the oxide (a1) and the composition containing the fluoropolymer (b), the composition containing the oxide (a1) and the composition containing the fluoropolymer (b) may be separate compositions, or may be the same composition. That is, a composition containing both of the oxide (a1) and the fluoropolymer (b) may be used. Preferred is a method of contacting the particles (X) with a composition containing both of the oxide (a1) and the fluoropolymer (b).

For example, a method of directly contacting the particles (X) with a composition (mixed powder) having the oxide (a1) in a powdery state and the fluoropolymer (b) in a powdery state mixed may be employed. Specifically, while the particles (X) are stirred, the above mixed powder is added thereto, and they are wholly uniformly mixed.

Otherwise, a method of contacting the particles (X) with a dispersion (liquid composition) containing both of the oxide (a1) and the fluoropolymer (b) may also be employed. For example, preferably employed is a spraying method of spraying a dispersion containing both of the oxide (a1) and the fluoropolymer (b) to the particles (x) while being stirred.

Otherwise, a stirring and mixing method of adding a dispersion containing both of the oxide (a1) and the fluoropolymer (b) to the particles (X) while being stirred may also be employed. As a stirring apparatus, a stirring machine with low shearing force such as a drum mixer or a solid air may be employed.

Particularly preferred is the spraying method, whereby the process is simple, and the particles of the oxide (a1) and the fluoropolymer (b) are likely to be uniformly attached to the surface of the particles (X).

The dispersion containing both of the oxide (a1) and the fluoropolymer (b) may be prepared, for example, by mixing a dispersion of the oxide (a1) and a solution or dispersion of the fluoropolymer (b).

In the composition to be contacted with the particles (X), the concentration of the oxide (a1) and the concentration of the fluoropolymer (b) are preferably high, since it is necessary to remove the dispersion medium by heating in the subsequent step. However, if the concentrations are too high, the viscosity tends to be too high, and uniform mixing property with the particles (X) will be decreased, further, spraying tends to be difficult.

The concentration of the particles of the oxide (a1) in the composition is preferably from 0.5 to 10 mass %, particularly preferably from 1 to 5 mass %. Further, the concentration of the fluoropolymer (b) in the composition is preferably from 0.1 to 10 mass %, more preferably from 0.5 to 5 mass %.

The amount of the oxide (a1) contained in the composition to be contacted with the particles (X) is, in a case where the particles (X) are lithium-containing composite oxide particles, such that the total molar amount of the metal element (M1) of the oxide (a1) is from 0.0001 to 0.08 time, more preferably from 0.0003 to 0.04 time, particularly preferably from 0.0005 to 0.03 time the total molar amount of the transition metal element in the particles (X). Within the above range, the discharge capacity tends to be large, and favorable rate characteristics and cycle characteristics are likely to be obtained. The same applies to a case where the particles (X) are not lithium-containing composite oxide particles.

The proportion of the oxide (a1) to the fluoropolymer (b) contained in the composition to be contacted with the particles (X) is preferably from 0.01/1 to 100/1, more preferably from 0.1/1 to 10/1 by the mass ratio of oxide (a1)/fluoropolymer (b). If the amount of the fluoropolymer (b) is too smaller than the above range, the oxide (a1) covers the most part of the surface of the particles (X), whereby the ion conductivity tends to be inhibited, and if the amount of the fluoropolymer (b) is too large, the contact between the oxide (a1) and the particles (X) tends to be insufficient.

### [Heating Step]

The particles (X) are contacted with the composition containing the oxide (a1) and the composition containing the fluoropolymer (b), followed by heating, whereby the oxide (a1) and the fluoropolymer (b) are attached to the surface of the particles (X) and in addition, the dispersion medium and volatile impurities such as an organic component are removed.

Heating is preferably carried out in an oxygen-containing atmosphere. For example, it may be carried out in the air. The heating temperature is preferably from 50 to 350° C., more preferably from 100 to 300° C. When the heating temperature is at least 50° C., the particles of the oxide (a1) and the fluoropolymer (b) are likely to be favorably attached to the surface of the particles (X), and in addition, volatile impurities such as remaining water tend to be small, whereby the cycle characteristics are less likely to be impaired. When the heating temperature is at most the upper limit of the above range, diffusion of the metal element (M) into the interior of the particles (X) tends to be suppressed, whereby a decrease in the capacity by diffusion is less likely to occur. Further, the fluoropolymer will not be thermally decomposed and will sufficiently be attached to the surface of the particles (X).

The heating time is not particularly limited and is preferably set so that volatile impurities such as remaining water can sufficiently be reduced. For example, it is preferably from 0.1 to 24 hours, more preferably from 0.5 to 18 hours, particularly preferably from 1 to 12 hours.

### <Method 2>

[Compound (a2)]

In (method 2), as the compound (a) containing the metal element (M), a compound (a2) having at least one metal element (M2) selected from the following metal element group (A2), forming an oxide of the metal element (M2) by heating, is used Such a compound (a2) may be used alone or in combination of two or more.

Metal element group (A2): a group consisting of Zr, Ti, Mn, Mo, Nb and Al.

Among the above element group, preferred is Zr, Nb or Al, more preferred is Al.

The compound (a2) containing Zr element is preferably ammonium zirconium carbonate, halogenated ammonium zirconium or zirconium acetate.

The compound (a2) containing Ti element is preferably titanium lactate ammonium salt, titanium lactate, titanium diisopropoxybis(triethanol aminate), peroxotitanium or titanium peroxocitric acid complex.

The compound (a2) containing Mn element is preferably manganese nitrate, manganese sulfate, manganese chloride, manganese acetate, manganese citrate, manganese maleate, manganese formate, manganese lactate or manganese oxalate.

The compound (a2) containing Mo element is preferably sodium molybdate, potassium molybdate, lithium molybdate, ammonium molybdate, molybdenum oxide or molybdenum hydroxide.

The compound (a2) containing Nb element is preferably an organic salt or an organic complex such as niobium nitrate, niobium sulfate, niobium chloride, niobium acetate, niobium citrate, niobium maleate, niobium formate, niobium lactate, ammonium niobium lactate, niobium oxalate, ammonium niobium oxalate, sodium niobate, potassium niobate, lithium niobate or ammonium niobate, niobium oxide or niobium hydroxide.

The compound (a2) containing Al element is preferably aluminum acetate, aluminum oxalate, aluminum citrate, aluminum lactate, basic aluminum lactate or aluminum maleate.

Among them, the compound (a2) is preferably ammonium zirconium carbonate, halogenated ammonium zirconium, titanium lactate, titanium lactate ammonium salt, manganese acetate, manganese citrate, manganese maleate, manganese oxalate, niobium oxalate, ammonium molybdate represented by (NH₄)₆Mo₇O₂₄, aluminum lactate or basic aluminum lactate, whereby the metal element concentration in the composition containing the compound (a2) tends to be high, it is likely to be decomposed by heat to form an oxide, it has a high solubility in a solvent, and a precipitate hardly forms even if the pH of the composition containing the compound (a2) is increased.

In a case where the particles (X) contain lithium element, particularly in a case where the particles (X) comprise the compound (iii), when such particles (X) are contacted with the composition containing the compound (a2), the pH of the composition is likely to be increased by lithium, and if the compound (a2) is precipitated on that occasion, adhesion uniformity on the surface of the particles (X) tends to be decreased.

[Composition Containing Compound (a2)]

As the composition containing the compound (a2), a solution having the compound (a2) dissolved in a solvent is used.

The solvent is preferably an aqueous medium composed mainly of water in view of the stability and the reactivity of the compound (a2). The aqueous medium is the same as the aqueous medium of the composition containing the fluoropolymer (b) including preferred embodiments.

The solution of the compound (a2) may contain a pH adjusting agent. The pH adjusting agent is preferably one which is volatilized or decomposed at the time of heating. Specifically, it is preferably an organic acid such as acetic acid, citric acid, lactic acid or formic acid or ammonia.

The pH of the solution of the compound (a2) is preferably from 3 to 12, more preferably from 3.5 to 12, particularly preferably from 4 to 10. When the pH is within the above range, impurities such as the pH adjusting agent tends to be small, whereby favorable battery characteristics are likely to be obtained. Further, in a case where the particles (X) contain Li element, when the particles (X) are contacted with the solution of the compound (a2), elution of the Li element from the particles (X) tends to be suppressed.

The solution of the compound (a2) is preferably prepared with heating as the case requires. The heating temperature is preferably from 40° C. to 80° C., particularly preferably from 50° C. to 70° C. By heating, dissolution of the compound (a2) in the solvent will easily proceed, and the compound (a2) can stably be dissolved.

[Step of Contacting Particles (X) with Composition]

In the step of contacting the particles (X) with the composition containing the compound (a2) and the composition containing the fluoropolymer (b), the composition containing the compound (a2) and the composition containing the fluoropolymer (b) may be separate compositions, or may be the same composition. That is, a composition containing both of the compound (a2) and the fluoropolymer (b) may be used. Preferred is a method of contacting the particles (X) with a composition containing both of the compound (a2) and the fluoropolymer (b).

Specifically, the particles (X) are contacted with a solution or dispersion (liquid composition) containing both of the compound (a2) and the fluoropolymer (b).

For example, preferred is a spraying method of spraying a liquid (solution or dispersion) containing both of the compound (a2) and the fluoropolymer (b) to the particles (X) while being stirred.

Otherwise, a stirring/mixing method of adding a liquid containing both of the compound (a2) and the fluoropolymer (b) to the particles (X) while being stirred may also be employed. As a stirring apparatus, a stirring machine with low shearing force such as a drum mixer or solid air may be employed.

Particularly preferred is a spraying method, whereby the process is simple, and the compound (a2) and the fluoropolymer (b) are likely to be uniformly attached to the surface of the particles (X).

The liquid containing both of the compound (a2) and the fluoropolymer (b) may be prepared, for example, by mixing a solution of the compound (a2) and a solution or dispersion of the fluoropolymer (b).

In the composition to be contacted with the particles (X), the concentration of the compound (a2) and the concentration of the fluoropolymer (b) are preferably high, since it is necessary to remove the dispersion medium and the solvent by heating in the subsequent step. However, if the concentrations are too high, the viscosity tends to be high, and uniform mixing property with the particles (X) will be decreased. Further, in a case where the particles (X) contains Ni, the composition is less likely to infiltrate into the Ni element source. Further, spraying tends to be difficult.

Accordingly, the concentration of the compound (a2) contained in the composition to be contacted with the particles (X) is preferably from 0.5 to 30 mass %, particularly preferably from 1 to 20 mass % as calculated as an oxide of the metal element (M2) contained in the compound (a2). Further, the concentration of the fluoropolymer (b) in the composition is preferably from 0.1 to 10 mass %, more preferably from 0.5 to 5 mass %.

The amount of the compound (a2) contained in the composition to be contacted with the particles (X) is, in a case where the particles (X) are lithium-containing composite oxide particles, such that the total molar amount of the metal element (M2) in the compound (a2) is preferably from 0.0001 to 0.05 time, more preferably from 0.0003 to 0.04 time, particularly preferably from 0.0005 to 0.03 time the total molar amount of the transition metal element in the particles (X). Within the above range, the discharge capacity tends to be large, and favorable rate characteristics and cycle characteristics are likely to be obtained. The applies to a case where the particles (X) are not lithium-containing composite oxide particles.

The proportion of the compound (a2) to the fluoropolymer (b) contained in the composition to be contacted with the particles (X) is preferably from 0.01/1 to 100/1, more preferably from 0.1/1 to 10/1 by the mass ratio of compound (a2)/fluoropolymer (b). If the amount of the fluoropolymer (b) is too smaller than the above range, the oxide formed by heating the compound (a2) covers the most part of the surface of the particles (X), whereby the ion conductivity is likely to be inhibited, and if the amount of the fluoropolymer (b) is too large, the contact between the compound (a2) and the particles (X) tends to be insufficient.

### [Heating Step]

As mentioned above, the particles (X) are contacted with the composition containing the compound (a2) and the composition containing the fluoropolymer (b), followed by heating, whereby an oxide of the metal element (M2) is formed, and the oxide and the fluoropolymer (b) are attached to the surface of the particles (X) and in addition, the dispersion medium or the solvent and volatile impurities such as an organic component are removed.

Heating is carried out in an oxygen-containing atmosphere. For example, it may be carried out in the air.

The heating temperature is preferably from 50 to 350° C. from the same reason as in the above (method 1). Particularly in this method, the heating temperature is preferably from 200 to 350° C., more preferably from 200 to 300° C., whereby the fluoropolymer is sufficiently attached without being decomposed, the compound (a2) is likely to be converted to the oxide (I), and further, volatile impurities such as remaining water tend to be small, whereby the cycle characteristics are less likely to be impaired.

The heating time is not particularly limited and is preferably set so that an oxide of the metal element (M2) is sufficiently formed and volatile impurities such as remaining water can sufficiently be reduced. For example, it is preferably from 0.1 to 24 hours, more preferably from 0.5 to 18 hours, particularly preferably from 1 to 12 hours.

### <Method 3>

[Water Soluble Compound (a3)]

In (method 3), as the compound (a) containing the metal element (M), a water soluble compound (a3) containing at least one metal element (M) selected from the following metal element group (A) is used. Such a water soluble compound (a3) may be used alone or in combination of two or more.

Metal element group (A): a group consisting of Li, Mg, Ca, Sr, Ba, Pb, Y, Ti, Zr, Hf, V, Nb, Ta, Cr, Mo, W, Mn, Fe, Co, Ni, Cu, Zn, Al, In, Sn, Sb, Bi, La, Ce, Pr, Nd, Gd, Dy, Er and Yb.

“Water soluble” here means a solubility (mass [g] of a solute which is dissolved in 100 g of a saturated solution) in distilled water at 25° C. of higher than 2. When the solubility is higher than 2, the content of the metal element (M) in the composition containing the water soluble compound (a3) can be made high, such being efficient. The solubility is more preferably higher than 5, particularly preferably higher than 10.

The water soluble compound (a3) containing the metal element (M) may, for example, be an inorganic salt such as nitrate, sulfate or chloride of the metal element (M); an organic salt or an organic complex such as acetate, citrate, maleate, formate, lactate or oxalate of the metal element (M); an oxoacid salt of the metal element (M); or an ammine complex of the metal element (M). Particularly preferred is a nitrate, an organic salt, an organic complex, an ammonium salt of oxoacid, or an ammine complex, which is likely to be decomposed by heat and has high solubility in a solvent.

### [Water Soluble Compound (c) Containing Anion (N)]

In (method 3), a water soluble compound (c) containing an anion (N) containing at least one element selected from the group consisting of S, P and F and reactive with the metal element (M) to form a hardly soluble metal salt, is used. Such a water soluble compound (c) may be used alone or in combination of two or more.

“Water soluble” here means that a solubility (the mass [g] of a solute which is dissolved in 100 g of a saturated solution) in distilled water at 25° C. of higher than 2. When the solubility is higher than 2, the content of the anion (N) in the composition containing the water soluble compound (c) can be made high, such being efficient. The solubility is more preferably higher than 5, particularly preferably higher than 10.

Further, “hardly soluble” means a solubility (the mass [g] of a solute which is dissolved in 100 g of a saturated solution) in distilled water at 25° C. of from 0 to 2. When the solubility is from 0 to 2, it is considered that such a salt is highly stable and hardly absorbs moisture, whereby impurities such as moisture will not remain, thus improving the cycle characteristics. The solubility of the hardly soluble salt is more preferably from 0 to 1, particularly preferably from 0 to 0.5.

The anion (N) may, for example, be specifically SO₄²⁻, SO₃²⁻, S₂O₃²⁻, SO₆²⁻, SO₈²⁻, PO₄³⁻, P₂O₇⁴⁻, PO₃³⁻, PO₂³⁻, F⁻, BO₃³⁻, BO₂⁻, B₄O₇²⁻or B₅O₈⁻. In view of the stability and handling efficiency, particularly preferred is SO₄²⁻, PO₄³⁻or F⁻.

The hardly soluble metal salt which is a reaction product of the anion (N) and the metal element (M) may, for example, be BaSO₄, CaSO₄, PbSO₄, SrSO₄, AIPO₄, LaPO₄, Ce₃(PO₄)₄, Mg₃(PO₄)₂, Li₃(PO₄)₂, Ba₃(PO₄)₂, Zr₃(PO₄)₄, Nb₃(PO₄)₅, Ca₃(PO₄)₂, Ba₃(PO₄)₂, CePO₄, BiPO₄, LaF₃, AlF₃, LiF, SrF₂, BaF₂, CeF₃, InF₃, MgF₂, MgF₂ or CaF₂, but is not limited thereto. Particularly preferred is AIPO₄, Nb₃(PO₄)₅, Zr₃(PO₄)₄ or AIF₃.

In addition to the above hardly soluble metal salt, a lithium salt formed by reaction of the anion N and lithium contained in the lithium-containing composite oxide may be contained. The lithium salt may, for example, be LiF, Li₃PO₄ or Li₂SO₄.

The water soluble compound (c) containing the anion (N) may be an acid such as H₂SO₄, H₂SO₃, H₂S₂O₃, H₂SO₆, H₂SO₈, H₃PO₄, H₄P₂O₇, H₃PO₃, H₃PO₂, HF, H₃BO₃, HBO₂, H₂B₄O₇ or HB₅O₈, or an ammonium salt, amine salt, lithium salt, sodium salt or potassium salt thereof. In view of handling efficiency and safety, it is preferred to use a salt rather than an acid. Further, particularly preferred is an ammonium salt, which is decomposed and removed when heated. Specifically, (NH₄)₂SO₄, (NH₄)HSO₄, (NH₄)₃PO₄, (NH₄)₂HPO₄, (NH₄)H₂PO₄ or NH₄F may be mentioned.

[Solution Containing Water Soluble Compound (a3)]
[Solution Containing Water Soluble Compound (c)]

In (method 3), as the composition containing the fluoropolymer (b), a solution or dispersion of the fluoropolymer (b) is used, and as the composition containing the water soluble compound (a3), a solution containing the water soluble compound (a3) (hereinafter sometimes referred to as solution (a3)) is used and in addition, a solution containing the water soluble compound (c) (hereinafter sometimes referred to as solution (c)) is used.

The solvent of the solution (a3) and the solution (c) is preferably an aqueous medium composed mainly of water in view of the safety and reactivity. The aqueous medium is the same as the aqueous medium of the composition containing the fluoropolymer (b) including the preferred embodiments.

Further, the solution (a3) may contain a pH adjusting agent. The pH adjusting agent is preferably one which is volatilized or decomposed when heated. Specifically, preferred is an organic acid such as acetic acid, citric acid, lactic acid, formic acid, maleic acid or oxalic acid, or ammonia. When a pH adjusting agent which is volatilized or decomposed is used, impurities are hardly remain, whereby favorable battery characteristics are likely to be obtained.

[Step of contacting particles (X) with solution]

As the solution or dispersion of the fluoropolymer (b), the solution (a3) and the solution (c) to be contacted with the particles (X), a solution or dispersion containing both of the fluoropolymer (b) and the water soluble compound (a3) and a separate solution (c) may be used; a solution or dispersion containing all of the fluoropolymer (b), the water soluble compound (a3) and the water soluble compound (c) may be used; or a solution containing both of the water soluble compound (a3) and the water soluble compound (c) and a separate solution or dispersion of the fluoropolymer (b) may be used.

It is preferred to contact the particles (X) with a solution containing at least both of the fluoropolymer (b) and the water soluble compound (a3), whereby the hardly soluble salt of the metal element (M) and the fluoropolymer (b) are likely to be uniformly attached to the surface of the particles (X).

Specifically, a method of contacting the particles (X) with a liquid (solution or dispersion) containing both of the fluoropolymer (b) and the water soluble compound (a3) and then with the solution (c); a method of contacting the particles (X) with the solution (c) and then with a liquid containing both of the fluoropolymer (b) and the water soluble compound (a3); a method of contacting both the liquids alternately several times; or a method of contacting the particles (X) with a liquid containing all of the fluoropolymer (b), the water soluble compound (a3) and the water soluble compound (c); may be suitably used.

The method of contacting the particles (X) with a liquid may be a spraying method of spraying the liquid while the particles (X) are stirred or a stirring/mixing method of adding the liquid to the particles (X) while being stirred, followed by stirring and mixing.

For example, preferred is a spraying method of spraying a liquid containing both of the fluoropolymer (b) and the water soluble compound (a3) to the particles (X) while being stirred, and spraying the solution (c).

Otherwise, a stirring/mixing method of adding a liquid containing all of the fluoropolymer (b), the water soluble compound (a3) and the water soluble compound (c) to the particles (X) while being stirred, followed by stirring and mixing may also be employed. As a stirring apparatus, a stirring machine with low shearing force such as a drum mixer or solid air may be employed.

Particularly preferred is a spraying method whereby the process is simple, and the hardly soluble metal salt which is a reaction product of the anion (N) and the metal element (M), and the fluoropolymer (b) are likely to be uniformly attached to the surface of the particles (X).

The liquid containing both of the fluoropolymer (b) and the water soluble compound (a3) is preferably a mixed liquid obtained by mixing a solution or dispersion of the fluoropolymer (b) and the solution (a3).

The liquid containing all of the fluoropolymer (b), the water soluble compound (a3) and the water soluble compound (c) is preferably a mixed liquid obtained by mixing a solution or dispersion of the fluoropolymer (b), the solution (a3) and the solution (c).

The metal element (M) contained in the liquid to be contacted with the particles (X) may be one type or two or more types. Further, the anion (N) may be one type or two or more types.

The concentration of the fluoropolymer (b), the concentration of the water soluble compound (a3) and the concentration of the water soluble compound (c) in the liquid to be contacted with the particles (X) are preferably high, since it is necessary to remove the solvent by heating in the subsequent step. However, if the concentrations are too high, the viscosity tends to be high, and the uniform mixing property with the particles (X) will be decreased, further, spraying tends to be difficult.

The concentration of the water soluble compound (a3) is preferably from 0.5 to 30 mass %, particularly preferably from 1 to 20 mass % as calculated as the metal element (M). The concentration of the water soluble compound (c) is preferably from 0.5 to 30 mass %, particularly preferably from 1 to 20 mass % as calculated as the anion (N). The concentration of the fluoropolymer (b) is preferably from 0.1 to 10 mass %, more preferably from 0.5 to 5 mass %.

The amount of the water soluble compound (a3) contained in the liquid to be contacted with the particles (X) is, in a case where the particles (X) are lithium-containing composite oxide particles, such that the total molar amount of the metal element (M) in the water soluble compound (a3) is preferably from 0.001 to 0.05 time, more preferably from 0.003 to 0.04 time, particularly preferably from 0.005 to 0.03 time the total molar amount of the transition metal element in the particles (X). Within the above range, the discharge capacity tends to be large, and favorable rate characteristics and cycle characteristics are likely to be obtained. The same applies to a case where the particles (X) are not lithium-containing composite oxide particles.

In (method 3), the proportion represented by {total amount of metal element (M) contained in water soluble compound (a3)×average valence of metal element (M)}/{total amount of anion (N) contained in water soluble compound (c)×average valence of anion (N)} is preferably from 0.1 to 10. Within such a rate, excellent cycle characteristics and rate characteristics will be obtained. The proportion is more preferably from 0.2 to 4, particularly preferably from 0.3 to 2.

Further, when the proportion is less than 1, the charge and discharge efficiency will be improved, such being favorable. It is considered that since the negative charge by the anion (N) is more significant than the positive charge by the metal element (M), excess lithium contained in the lithium-containing composite oxide is bonded to the anion (N), thus improving the charge and discharge efficiency. In view of the charge and discharge efficiency, the proportion is preferably from 0.1 to 0.99, more preferably from 0.2 to 0.9, particularly preferably from 0.3 to 0.8.

In the covering layer formed on the surface of the particles (X), the entire metal element (M) may form a metal salt with the anion (N), or a part of the metal element (M) may be in the form of an oxide or a hydroxide.

The proportion of the water soluble compound (a3) to the fluoropolymer (b) contained in the liquid to be contacted with the particles (X) is preferably from 0.01/1 to 100/1, more preferably from 0.1/1 to 10/1 by the mass ratio of water soluble compound (a3)/fluoropolymer (b). If the amount of the fluoropolymer (b) is too smaller than the above range, the hardly soluble salt obtainable by mixing the water soluble compound (a3) and the water soluble compound (c) covers the most part of the surface of the particles (X), whereby the ion conductivity is likely to be inhibited, and if the amount of the fluoropolymer (b) is too large, the contact between the compound (a3) and the particles (X) tends to be insufficient.

### [Heating Step]

As mentioned above, the particles (X) are contacted with the liquid containing the fluoropolymer (b), the liquid containing the water soluble compound (a3), and the liquid containing the water soluble compound (c), followed by heating, whereby a hardly soluble salt of the metal element (M) is formed, and the hardly soluble salt and the fluoropolymer (b) are attached to the surface of the particles (X) and in addition, the dispersion medium or the solvent and volatile impurities such as an organic component are removed.

Heating is preferably carried out in an oxygen-containing atmosphere. For example, it may be carried out in the air.

The heating temperature is preferably from 50 to 350° C. from the same reason as in the above (method 1). Further, in this method, the heating temperature is preferably from 200 to 350° C., more preferably from 250 to 350° C., whereby the fluoropolymer is sufficiently attached without being decomposed, and further, volatile impurities such as remaining water tend to be small, whereby the cycle characteristics are less likely to be impaired.

The heating time is not particularly limited and is preferably set so that the hardly soluble salt of the metal element (M) is sufficiently formed, and volatile impurities such as remaining water can sufficiently be reduced. For example, it is preferably from 0.1 to 24 hours, more preferably from 0.5 to 18 hours, particularly preferably from 1 to 12 hours.

### <Electrode for Lithium Ion Secondary Battery>

The electrode for a lithium ion secondary battery of the present invention (hereinafter sometimes referred to simply as electrode) comprises an electrode active material layer containing the active material particles obtained by the production method of the present invention, an electrically conductive material and a binder. Preferably, it has a current collector and an electrode active material layer formed on the current collector, and the electrode active material layer contains active material particles obtained by the production method of the present invention, an electrically conductive material and a binder.

### [Current Collector]

As the material of the current collector, a known material used for a current collector of an electrode for a lithium ion secondary battery may properly be used.

For example, as a current collector for a cathode, a metal such as aluminum, titanium or tantalum or its alloy may be mentioned. Among them, preferred is aluminum or its alloy, more preferred is aluminum.

The current collector for an anode, copper, nickel, stainless steel or the like may be mentioned, and copper is preferred.

### [Electrically Conductive Material]

As the electrically conductive material, carbon black such as acetylene black, graphite or ketjen black may be mentioned. Such electrically conductive materials may be used alone or in combination of two or more.

### [Binder]

As the binder, an optional binder known for an electrode may be used so long as it is a material stable against the electrolyte and the solvent to be used at the time of preparing the electrodes.

For example, a fluorinated resin such as polyvinylidene fluoride or polytetrafluoroethylene, a polyolefin such as polyethylene or polypropylene, a polymer or copolymer having unsaturated bonds such as a styrene/butadiene rubber, isoprene rubber or butadiene rubber, or an acrylic acid type polymer or copolymer such as an acrylic acid copolymer or a methacrylic acid copolymer may be mentioned. These binders may be used alone or in combination of two or more.

### [Other Component]

The electrode active material layer may contain, in addition to the active material particles, the electrically conductive material and the binder, as the case requires, a thickener, a filler or the like to increase the mechanical strength and the electrical conductivity.

The thickener may, for example, be carboxymethylcellulose, methylcellulose, hydroxymethylcellulose, ethylcellulose, polyvinyl alcohol, oxidized starch, phosphorylated starch, casein or polyvinylpyrrolidone. Such thickeners may be used alone or in combination of two or more.

The content of the active material particles in the electrode active material layer is not particularly limited, however, if it is too low, the battery capacity per electrode will be insufficient, and if it is too high, the amount of the binder or the electrically conductive material is relatively insufficient, and the adhesion and the electrical conductivity of the electrode will be decreased, and accordingly, it is properly set to avoid such disadvantages. For example, the content of the active material particles is preferably from 60 to 99 mass %, more preferably from 80 to 98 mass % in the entire (100 mass %) solid material (solid content) constituting the electrode active material layer.

In such a case, in the entire (100 mass %) solid material (solid content) constituting the electrode active material layer, the content of the electrically conductive material is preferably from 0.5 to 15 mass %, the content of the binder is preferably from 0.5 to 15 mass %, and when other component is contained, the content of such other component is preferably at most 2 mass %.

### <Lithium Ion Secondary Battery>

The lithium ion secondary battery of the present invention (hereinafter sometimes referred to simply as secondary batter) comprises a cathode, an anode and an electrolyte, wherein the cathode and/or the anode comprises the electrode for a lithium ion secondary battery of the present invention.

The active material particles of the present invention are suitable as cathode active material particles, and preferred is a secondary battery wherein the cathode comprises the electrode for a lithium ion secondary battery of the present invention. In such a case, as the anode, an electrode known as an anode for a lithium ion secondary battery may be used.

As the electrolyte, a non-aqueous electrolyte is suitably used. As the non-aqueous electrolyte, a known non-aqueous electrolyte having an electrolyte salt dissolved in a non-aqueous solvent may be properly used.

The electrolyte salt is a salt which forms an ion when dissolved or dispersed in a non-aqueous solvent and is preferably a lithium salt.

The lithium salt may, for example, be lithium perchlorate (LiClO₄), lithium hexafluoroarsenate (LiAsF₆), lithium hexafluorophosphate (LiPF₆), lithium tetrafluoroborate (LiBF₄), LiB (C₆H₅)₄, CH₃SO₃Li, CF₃SO₃Li, LiCl or LiBr. The lithium salt may be used alone or in combination of two or more.

Between the cathode and the anode of the secondary battery, a porous film is usually interposed as a separator in order to prevent short circuiting. In such a case, the non-aqueous electrolyte with which the porous film is impregnated is used. The material and the shape of the porous film are not particularly limited so long as it is stable against the non-aqueous electrolyte and is excellent in the liquid-maintaining property. The porous film is preferably a porous sheet or a non woven fabric made of a fluorinated resin such as polyvinylidene fluoride, polytetrafluoroethylene or a copolymer of ethylene and tetrafluoroethylene, or a polyolefin such as polyethylene or polypropylene, and as the material, a polyolefin such as polyethylene or polyolefin is preferred. Further, such a porous film impregnated with the electrolyte and gellated may be used as a gel electrolyte.

The shape of the secondary battery may be selected depending upon the particularly application, and it may be a coin-form, a cylinder form, a square form or a laminate-form. Further, the shapes of the cathode and the anode may also be selected to meet with the shape of the secondary battery.

The material for a battery exterior package may be a material which is commonly used for a secondary battery, and nickel-plated iron, stainless steel, aluminum or its alloy, nickel, titanium, a resin material or a film material may, for example, be mentioned.

The charge cut-off voltage of the secondary battery of the present invention is preferably at least 4.20 V, more preferably at least 4.50 V. Further, the discharge cut-off voltage is preferably from 2.00 to 3.30 V. The higher the charge cut-off voltage and the discharge cut-off voltage, the higher the energy density.

Here, the secondary battery of the present invention is not limited to the above-described secondary battery so long as it has the electrode for a lithium ion secondary batter of the present invention formed by using the active material particles obtained by the production method of the present invention.

The secondary battery of the present invention is useful for various applications to, for example, mobile phones, portable game devices, digital cameras, digital video cameras, electric tools, notebook computers, portable information terminals, portable music players, electric vehicles, hybrid automobiles, electric trains, aircrafts, artificial satellites, submarines, ships, uninterruptible power supply systems, robots, electric power storage systems, and so on. Further, the secondary battery of the present invention has characteristics preferred particularly for large-sized secondary batteries of e.g. electric vehicles, hybrid automobiles, electric trains, aircrafts, artificial satellites, submarines, ships, uninterruptible power supply systems, robots, electric power storage systems, and so on.

According to the present invention, active material particles having a covering layer containing an oxide or salt having the metal element (M) and the fluoropolymer (b) on their surface are obtained. By constituting a lithium ion secondary battery using such active material particles, it is possible to obtain a secondary battery, which is excellent in the cycle characteristics, which has a small internal resistance, whereby a high output can be obtained, and in which decomposition of the electrolyte is favorably suppressed even by use at a high voltage, as shown in the after-mentioned Examples.

With respect to such a secondary battery, it is considered that the covering layer interposed between the active material particles and the electrolyte and the fluoropolymer (b) constituting the covering layer being excellent in the oxidation resistance, contribute particularly to suppression of decomposition of the electrolyte, a part of the surface of the active material particles being covered with an oxide or salt having the metal element (M) contributes particularly to prevention of deterioration of the active material particles and improvement in the cycle characteristics, and a part of the covering layer comprising the fluoropolymer (b) having lithium ion conductivity contributes to a decrease in the internal resistance and an improvement in the output.

Further, since the covering layer containing the fluoropolymer (b) has favorable surface smoothness, it is possible to pack the electrode with the active material particles at a high density, whereby the energy density per unit volume in the electrode can be improved.

### EXAMPLES

Now, the present invention will be described in further detail with reference to Examples. However, the present invention is by no means restricted to such specific Examples.

### <Active Material Particles (X) for Lithium Ion Secondary Battery>

### [Production of Lithium-Containing Composite Oxide Particles (X1)]

Nickel(II) sulfate hexahydrate (140.6 g), cobalt(II) sulfate heptahydrate (131.4 g) and manganese(II) sulfate pentahydrate (482.2 g) were mixed with distilled water (1,245.9 g) and uniformly dissolved to obtain a material solution. Ammonium sulfate (79.2 g) was mixed with distilled water (320.8 g) and uniformly dissolved to obtain an ammonia solution. Ammonium sulfate (79.2 g) was mixed with distilled water (1,920.8 g) and uniformly dissolved to obtain a mother liquid. Sodium hydroxide (400 g) was mixed with distilled water (600 g) and uniformly dissolved to obtain a pH adjusting liquid.

The mother liquid was put in a 2 L (liter) glass reaction tank provided with a baffle and heated to 50° C. by a mantle heater, and the pH adjusting liquid was added so that the pH became 11.0. While the solution in the reaction tank was stirred by an anchor type stirring blade, the material solution and the ammonia source solution were added at rates of 5.0 g/min and 1.0 g/min, respectively, whereby a composite hydroxide of nickel, cobalt and manganese was precipitated. While the material solution was added, the pH adjusting liquid was added to keep the pH in the reaction tank at 11.0. Further, nitrogen gas was made to flow at a flow rate of 0.5 L/min through the reaction tank so that the precipitated hydroxide would not be oxidized. Further, the liquid was continuously withdrawn so that the liquid amount in the reaction tank would not exceed 2 L.

To remove impurity ions from the obtained composite hydroxide of nickel, cobalt and manganese, the composite hydroxide was cleaned by repeatedly carrying out pressure filtration and dispersion in distilled water. Cleaning was completed when the electric conductivity of the filtrate became 25 μS/cm, and the composite hydroxide was dried at 120° C. for 15 hours to obtain a precursor. The nickel, cobalt and manganese contents in the precursor were measured by ICP, whereupon they were 11.6 mass %, 10.5 mass % and 42.3 mass %, respectively (nickel:cobalt:manganese by the molar ratio=0.172:0.156:0.672).

The precursor (20 g) and lithium carbonate (12.6 g) having a lithium content of 26.9 mol/kg were mixed and fired in an oxygen-containing atmosphere at 800° C. for 12 hours to obtain lithium-containing composite oxide particles (X1). The composition of the obtained lithium-containing composite oxide particles (X1) is Li(Li_{0.2}Ni_{0.137}CO_{0.125}Mn_{0.538})O₂. Of the lithium-containing composite oxide particles (X1), the average particle size D50 was 5.3 μm, and the specific surface area measured by BET (Brunauer, Emmett, Teller) method was 4.4 m²/g.

<Composition Containing Compound (a)>

As a composition containing the compound (a) having the metal element (M), water was added to an acidic aqueous dispersion (manufactured by Sakai Chemical Industry Co., Ltd., tradename: SZR Zirconia aqueous dispersion) of zirconia oxide (ZrO₂) particles having a zirconium content of 30 mass % as calculated as ZrO₂ to prepare a ZrO₂ dispersion having a pH of 3.9 and a concentration of 2 mass %. The average particle size of zirconia oxide (ZrO₂) particles is 3.7 nm.

<Composition Containing Fluoropolymer (b)>

As the fluoropolymer (b), a tetrafluoroethylene/propylene copolymer was used. The copolymer may be produced by a known method. For example, in accordance with a method disclosed in JP-A-55-127412, tetrafluoroethylene as a monomer corresponding to structural units (1) and propylene as a monomer corresponding to structural units (2) are copolymerized to obtain a tetrafluoroethylene/propylene copolymer. Further, a commercially available product may also be used.

The tetrafluoroethylene/propylene copolymer (b1) used in the following Examples and Comparative Examples has 56 mol % of tetrafluoroethylene units and 44 mol % of propylene units. Further, the weight average molecular weight is 130,000.

As a composition containing the fluoropolymer (b), an aqueous dispersion having the tetrafluoroethylene/propylene copolymer (b1) dispersed in water at a concentration of 2 mass % was used. In the aqueous dispersion, the average particle size of the fluoropolymer (b) was 120 nm.

### Example 1

### Production of Cathode Active Material Particles

First, 15 g of the aqueous dispersion (concentration: 2 mass %) of the tetrafluoroethylene/propylene copolymer (b1) was added to and mixed with 15 g of the ZrO₂ dispersion (concentration: 2 mass %) to obtain a mixed liquid having a ZrO₂ concentration of 1 mass % and a tetrafluoroethylene/propylene copolymer (b1) concentration of 1 mass %.

Then, 15 g of the mixed liquid was sprayed to and mixed with to 15 g of the particle (X1) with stirring to obtain a mixture. The ratio of (total number of mols of Zr)/(number of mols of Ni, Co and Mn in total) contained in the mixture is 0.0086/1.

The obtained mixture was heated in the air at 300° C. for one hour to obtain cathode active material particles having ZrO₂ particles and the tetrafluoroethylene/propylene copolymer (b1) attached to the surface of the particles (X1).

### Comparative Example 1

In this Example, the lithium-containing composite oxide particles (X1) are used as the cathode active material particles.

### Comparative Example 2

In this Example, using a dispersion having a ZrO₂ concentration of 1 mass % obtained by adding water to the ZrO₂ dispersion (concentration: 2 mass %), the lithium-containing composite oxide particles (X1) were covered.

That is, 15 g of the ZrO₂ dispersion (concentration: 1 mass %) was sprayed to and mixed with 15 g of the lithium-containing composite oxide particles (X1) with stirring to obtain a mixture.

The obtained mixture was heated in the air at 300° C. for one hour to obtain cathode active material particles having the ZrO₂ particles attached to the surface of the lithium-containing composite oxide particles (X1).

### Comparative Example 3

In this Example, using an aqueous dispersion having a concentration of the tetrafluoroethylene/propylene copolymer (b1) of 1 mass % obtained by adding water to the aqueous dispersion (concentration: 2 mass %) of the copolymer (b1), the lithium-containing composite oxide particles (X1) were covered.

That is, 15 g of the aqueous dispersion (concentration: 1 mass %) of the tetrafluoroethylene/propylene copolymer (b1) was sprayed to and mixed with 15 g of the lithium-containing composite oxide particles (X1) with stirring to obtain a mixture.

The obtained mixture was heated in the air at 300° C. for one hour to obtain cathode active material particles having the tetrafluoroethylene/propylene copolymer (b1) attached to the surface of the lithium-containing composite oxide particles (X1).

### <Production of Cathode>

A cathode was produced using each of the cathode active material particles obtained in Example and Comparative Examples.

That is, 80 parts by mass of the cathode active material particles, 12 parts by mass of acetylene black (electrically conductive material) and a polyvinylidene fluoride solution (solvent: N-methylpyrrolidone, polymer concentration: 12.1 mass %) containing 8 parts by mass of polyvinylidene fluoride (binder) were mixed, and N-methylpyrrolidone was further added to prepare a slurry. The slurry was applied on one side of an aluminum foil (cathode current collector) having a thickness of 20 μm by means of a doctor blade, followed by drying at 120° C. and roll pressing twice to prepare a cathode sheet to be a cathode for a lithium battery.

### <Production of Battery>

One punched out into a circle having a diameter of 18 mm from the above-produced cathode sheet was used as a cathode, a metal lithium foil having a thickness of 500 μm was used as an anode, a stainless steel plate having a thickness of 1 mm was used as an anode current collector, and a porous polypropylene having a thickness of 25 μm was used as a separator. Further, as an electrolyte, a mixed solution having LiPF₆ as a solute dissolved in EC (ethylene carbonate) and DEC (diethyl carbonate) in a volume ratio (EC:DEC) of 1:1 as a solvent and having a LiPF₆ concentration of 1 mol/dm³ was used.

Using them, a stainless steel simple sealed cell type lithium secondary battery was assembled in an argon globe box.

### <Evaluation Method>

### [Charge and Discharge Test]

The discharge characteristics of the secondary battery were evaluated by the following test method. The results are shown in Table 1.

In the following, 1C represents a current value to discharge the standard capacity of a battery in one hour, and 0.5 C represents a current value of ½ thereof.

A cycle of charging the secondary battery to 4.5 V (the voltage means a voltage to lithium) with a constant current corresponding to 0.5 C and then discharging it until the current became 0.05 C at the charge upper limit voltage and discharging it to 3 V with a constant current corresponding to 0.5 C, was carried out at 25° C. for 5 cycles to stabilize the secondary battery.

In the sixth cycle, the secondary battery was charged to 4.5 V with a constant current of 0.5 C, charged it until the current became 0.05 C at the charge upper limit voltage and then discharged to 3 V with a constant current of 1.0 C.

In the seventh cycle, the secondary battery was charged to 4.5 V with a constant current of 0.5 C, charged until the current became 0.05 C at the charge upper limit voltage and then discharged to 3 V with a constant current of 2.0 C.

In the eighth cycle, the secondary battery was charged to 4.5 V with a constant current of 0.5 C, charged until the current became 0.05 C at the charge upper limit voltage and then discharged to 3 V with a constant current of 3.0 C.

In the ninth and subsequent cycles, the test was continued under the same conditions as for the first to fifth cycles.

### [Cycle Retention Rate]

In the above charge and discharge test, a value obtained by dividing the discharge capacity in the 100th cycle by the discharge capacity in the first cycle is taken as the cycle retention rate. Based on the cycle retention rate in Comparative Example 1 as 0, a higher cycle retention rate is regarded as +, and a lower cycle retention rate is regarded as −. ++ means a higher rate than +, and +++ means a further higher rate.

### [Output Under High C Rate Conditions]

In the above charge and discharge test, a value obtained by dividing the discharge capacity (discharge at 3.0 C) in the ninth cycle by the discharge capacity in the first cycle is taken as the cycle retention rate at 3.0 C rate, to evaluate characteristics at high C rate. In the same manner as above, based on the retention rate in Comparative Example 1 as 0, the retention rate is evaluated by + or −.

### [Formation of Gas]

The secondary battery is charged to 4.5 V with a constant current corresponding to 0.5 C at 25° C. and then left to stand in an environment at 60° C. for 48 hours, and a gas in the battery is collected to judge whether a gas is formed or not.

TABLE 1

| | Cycle retention | Output under high C | |
|---|---|---|---|
| | rate | rate conditions | Gas formation |
| Ex. 1 | +++ | ++ | Not formed |
| Comp. Ex. 1 | 0 | 0 | Formed |
| Comp. Ex. 2 | ++ | − | Formed |
| Comp. Ex. 3 | + | + | Not formed |

As evident from the results in Table 1, in Example 1 in which the ZrO₂ particles and the tetrafluoroethylene/propylene copolymer (b1) were attached to the lithium-containing composite oxide particles (X1), the cycle retention rate and the output at high C rate were improved, and formation of a gas when the lithium battery was used at a high voltage was prevented, as compared with Comparative Example 1 in which the lithium-containing composite oxide particles (X1) were used as the cathode active material. Formation of a gas indicates that the electrolyte was decomposed.

On the other hand, in Comparative Example 2 in which the ZrO₂ particles were attached to the particles, although the cycle retention rate was improved, the output at high C rate was poor, and formation of a gas was observed when the secondary battery was used at a high voltage, as compared with Comparative Example 1.

Further, in Comparative Example 3 in which the tetrafluoroethylene/propylene copolymer (b1) was attached to the particles, the cycle retention rate was slightly improved and the output at high C rate was improved as compared with Comparative Example 1, however, the cycle retention rate and the output at high C rate were poor as compared with Example 1.

The reason why the output at high C rate in Comparative Example 3 was improved as compared with Comparative Example 1 is considered to be such that since the surface of the cathode active material particles was covered with the copolymer (b1), dispersibility of acetylene black in the slurry containing the cathode active material particles, acetylene black and the binder was improved when the cathode was produced.

### INDUSTRIAL APPLICABILITY

According to the present invention, it is possible to obtain active material particles for a lithium ion secondary battery, which have a small internal resistance, with which decomposition of the electrolyte can be suppressed even by use at a high voltage, and which are excellent in the cycle characteristics. The active material particles are useful for lithium ion secondary batteries for electronic instruments such as mobile phones, and for vehicles, which are small in size and light in weight.

This application is a continuation of PCT Application No. PCT/JP2012/066059, filed on Jun. 22, 2012, which is based upon and claims the benefit of priority from Japanese Patent Application No. 2011-140492 filed on Jun. 24, 2011. The contents of those applications are incorporated herein by reference in its entirety.

What is claimed is:

1. A method for producing active material particles for a lithium ion secondary battery, which comprises contacting active material particles (X) for a lithium ion secondary battery capable of oxidation/reduction reaction, with a composition containing a compound (a) having at least one metal element (M) selected from the following metal element group (A) and a composition containing the following fluoropolymer (b), and heating them:
metal element group (A): a group consisting of Li, Mg, Ca, Sr, Ba, Pb, Y, Ti, Zr, Hf, V, Nb, Ta, Cr, Mo, W, Mn, Fe, Co, Ni, Cu, Zn, Al, In, Sn, Sb, Bi, La, Ce, Pr, Nd, Gd, Dy, Er and Yb;
fluoropolymer (b): a polymer having repeating units represented by the following formula (1):
—[CF₂—CR¹R²]— (1)
wherein each of R¹ and R² is a hydrogen atom, a fluorine atom or a trifluoromethyl group.

2. The production method according to claim 1, wherein the contacting step is a step of contacting the particles (X) with a composition containing both of the compound (a) and the fluoropolymer (b).

3. The production method according to claim 1, wherein the composition containing the compound (a) is a powder or dispersion of an oxide (a1) of at least one metal element (M1) selected from the following metal element group (A1); and the composition containing the fluoropolymer (b) is a powder, solution or dispersion of the fluoropolymer (b).
metal element group (A1): a group consisting of Zr, Ti, Sn, Mg, Ba, Pb, Bi, Nb, Ta, Zn, Y, La, Sr, Ce, In and Al.

4. The production method according to claim 3, wherein the oxide (a1) is at least one member selected from the group consisting of ZrO₂, TiO₂, SnO₂, MgO, BaO, PbO, Bi₂O₃, Nb₂O₅, Ta₂O₅, ZnO, Y₂O₃, La₂O₃, Sr₂O₃, CeO₂, In₂O₃, Al₂O₃, indium tin oxide (ITO), yttria-stabilized zirconia (YSZ), metal barium titanate, strontium titanate and zinc stannate.

5. The production method according to claim 3, wherein the composition containing the compound (a) is a dispersion of the oxide (a1), and the composition containing the fluoropolymer (b) is a solution or dispersion.

6. The production method according to claim 5, wherein the contacting step is a step of spraying a dispersion containing both of the oxide (a1) and the fluoropolymer (b) to the active material particles (X) for a lithium ion secondary battery.

7. The production method according to claim 1, wherein heating is carried out at a temperature of from 50 to 350° C.

8. The production method according to claim 1, wherein the fluoropolymer (b) is at least one member selected from the group consisting of polytetrafluoroethylene (PTFE), polyvinylidene fluoride (PVdF), a tetrafluoroethylene/ethylene copolymer (ETFE), a tetrafluoroethylene/propylene copolymer and a tetrafluoroethylene/sulfonyl group-containing perfluorovinyl ether copolymer.

9. The production method according to claim 1, wherein the active material particles (X) for a lithium ion secondary battery are lithium-containing composite oxide particles.

10. The production method according to claim 9, wherein the lithium-containing composite oxide particles contain Li element and at least one transition metal element selected from the group consisting of Ni, Co and Mn, the molar amount of the Li element being more than 1.2 times of the total molar amount of the transition metal element.

11. An electrode for a lithium ion secondary battery, which comprises an electrode active material layer containing the active material particles for a lithium ion secondary battery obtained by the production method as defined in claim 1, an electrically conductive material and a binder.

12. A lithium ion secondary battery comprising the electrode for a lithium ion secondary battery as defined in claim 11.
